(19) United States
(12) Patent Application Publication
(10) Pub. No.: US 2018/0127089 A1
(43) Pub. Date: May 10, 2018

(54) Turboelectric Aircraft with Aft Propulsion

(71) Applicant: U.S.A. as represented by the Administrator of the National Aeronautics and Space Administration, Washington, DC (US)

(72) Inventors: Jason R. Welstead, Newport News, VA (US); James L. Felder, Westlake, OH (US)

(73) Assignee: U.S.A. as represented by the Administrator of the National Aeronautics and Space Administration

(21) Appl. No.: 15/343,847

(22) Filed: Nov. 4, 2016

(51) Int. Cl. B64C 21/06; B64C 1/16; B64D 27/18; B64D 27/24; B60L 11/14

(52) U.S. Cl. CPC B64C 21/06; B64C 1/16; B64D 2027/026; B64D 27/24; B60L 11/14; B64D 27/18

(57) ABSTRACT

A turboelectric vehicle may include a fuselage and a wing coupled to the fuselage. A wing propulsor may be coupled to the wing. A rear propulsor may be positioned at a rear portion of the fuselage and may be electrically coupled to the wing propulsor. The rear propulsor may be configured to receive power extracted from the wing propulsor.

### STATEMENT REGARDING FEDERALLY SPONSORED RESEARCH OR DEVELOPMENT

The invention described herein was made by employees of the United States Government and may be manufactured and used by or for the Government of the United States of America for governmental purposes without the payment of any royalties thereon or therefore.

### BACKGROUND OF THE INVENTION

Commercial transport aircraft often employ tube-and-wing designs with one or more engines along each of the wings. These engines include hydrocarbon fuel-burning turbomachinery. Reduction in fuel burn, noise and emissions drive design concerns in many various types of aircraft vehicles. However, transport aircraft configurations have generally provided limited opportunities for optimization of such design constraints.

Prior solutions for aircraft vehicles have not resolved the need for an approach to perform one or more of the above actions without drawbacks, e.g., mechanical or electrical complexity, size and weight constraints, and/or cost-prohibitive. Therefore, there is a need for aircraft vehicle systems and methods that address one or more of the deficiencies described above amongst others.

### BRIEF SUMMARY OF THE INVENTION

The present invention is related to systems and methods relating to turboelectric aircraft vehicles employing turboelectric system architecture and an aft electrically-driven propulsor.

The following presents a general summary of aspects of this invention in order to provide a basic understanding of at least some aspects of the invention. This summary is not an extensive overview of the invention. It is not intended to identify key or critical elements of the invention or to delineate the scope of the invention. The following summary merely presents some concepts of the invention in a general form as a prelude to the more detailed description provided below. In this regard, this disclosure provides several examples of novel turboelectric vehicles with turboelectric propulsion systems. As would be understood by a person of ordinary skill in the art, the disclosed propulsion systems may be configured for different vehicles, and as such, may not require certain vehicular requirements and/or any vehicle disclosed herein.

One embodiment of the invention is a single-aisle commercial transport vehicle with turboelectric propulsion system architecture. The turboelectric propulsion system architecture may include two underwing turbofans. Each turbofan may include a fan, a fan shaft driven by the fan, and a generator configured to extract power from the fan shaft and send the extracted power to a rear fuselage, axisymmetric, boundary-layer-ingesting fan.

One embodiment of the invention is a turboelectric vehicle including a fuselage, a wing coupled to the fuselage, a wing propulsor coupled to the wing, and a rear propulsor positioned at a rear portion of the fuselage and electrically coupled to the wing propulsor. The rear propulsor may be configured to receive power extracted from the wing propulsor. The wing propulsor may include a turbofan including a fan, a fan shaft driven by rotation of the fan, and a generator configured to extract power from the fan shaft for sending to the rear propulsor. The rear propulsor may be sized and positioned to ingest a portion of a boundary layer at the rear portion of the fuselage.

A single rear propulsor disclosed herein may be positioned to cover a rear tail cone of the fuselage. An electric motor may be included to drive the rear propulsor and powered by the extracted power from the wing propulsor. The turboelectric vehicle may be a single-aisle transport aircraft, a double-aisle aircraft, or the like. The wing may include a pair of wings on opposing sides of the fuselage, and the wing propulsor may include a pair of turbofans, each positioned on a lower surface of the pair of wings. A T-tail empennage may be included and positioned at an aft end of fuselage and above the rear propulsor.

Another embodiment of the invention relates to a turboelectric propulsion system including a wing propulsor powered by fuel combustion, an electrically powered rear propulsor aft of the wing propulsor, and an electric system electrically coupling the wing propulsor to the rear propulsor. The electric system may include a generator coupled to the wing propulsor and configured to extract power generated by the wing propulsor, an electric motor configured to receive the extracted power from the generator and to power the rear propulsor, and a cabling system configured to electrically connect the generator to the electric motor. The electric system may further include an inverter coupled to the generator.

The wing propulsor may include a turbofan with a fan and a fan shaft driven by rotation of the fan and providing power to the generator. The rear propulsor may include a ducted electrically-driven fan. The wing propulsor and the rear propulsor may each be axisymmetrically-shaped, and a diameter of the wing propulsor may be smaller than a diameter of the rear propulsor. The rear propulsor may be sized and positioned to ingest a portion of a boundary layer at a rear portion of a vehicle driven by the turboelectric propulsion system.

Yet another embodiment of the invention relates to a vehicle including a main body, a pair of fixed wings connected to opposing sides of the main body, a pair of wing propulsors coupled each respective wing of the pair of fixed wings, and an electrically-driven rear propulsor positioned at a rear portion of the main body and configured to receive power extracted from the pair of wing propulsors.

Each of the wing propulsors comprises a turbofan including a fan, a fan shaft driven by rotation of the fan, and a generator configured to extract power from the fan shaft to send to the rear propulsor. The rear propulsor may be sized and positioned to ingest all or a portion of a boundary layer along the rear portion of the main body. The rear propulsor may be positioned over a rear tail cone of the main body. The rear propulsor may include an electric motor powered by the extracted power from the wing propulsor. The rear propulsor may further include a ducted fan configured to be driven by the electric motor.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

The accompanying drawings, which are incorporated herein and constitute part of this specification, illustrate exemplary embodiments of the invention, and together with the Summary given above and the Detailed Description given below, serve to explain the features of the invention.

FIG. 1A is side view of a turboelectric vehicle in accordance with one or more aspects of the present disclosure;

FIG. 1B is perspective view of a turboelectric vehicle in accordance with one or more aspects of the present disclosure;

FIG. 2 is a side, cross-sectional view of a wing propulsor employed in the turboelectric vehicle of FIGS. 1A and 1B;

FIG. 3 is a side, schematic view of a rear fuselage portion of the turboelectric vehicle of FIGS. 1A and 1B; and

FIG. 4 is a schematic representation of an aft boundary layer profile of a turboelectric vehicle in accordance with one or more aspects of the present disclosure.

### DETAILED DESCRIPTION OF THE INVENTION

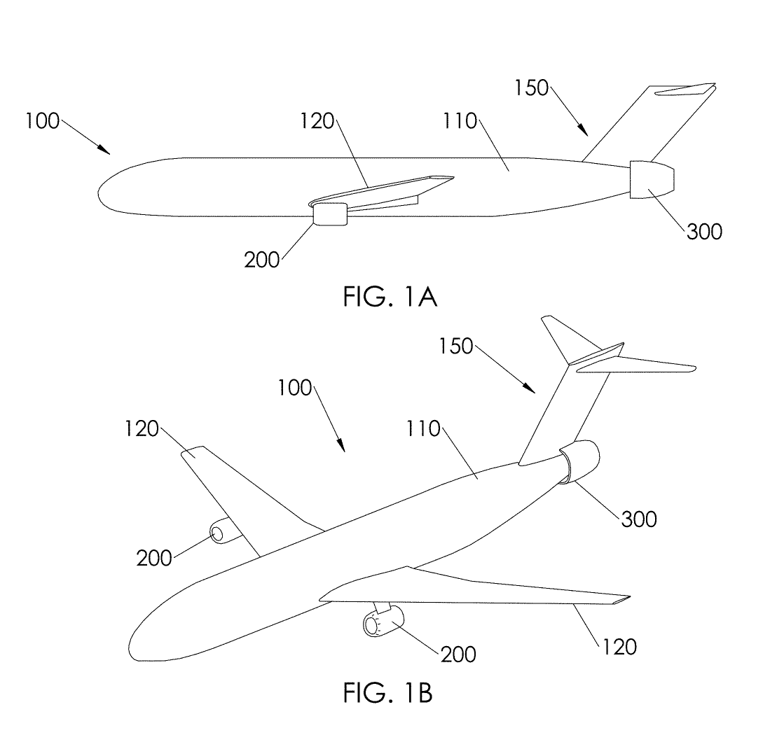

For purposes of description herein, the terms “upper,” “lower,” “right,” “left,” “rear,” “front,” “aft,” “forward,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In the following description of various examples of the invention, reference is made to the accompanying drawings which show, by way of illustration, various example systems and environments in which aspects of the present disclosure may be practiced. It is to be understood that other specific arrangements of parts, example systems, and environments may be utilized and structural and functional modifications may be made without departing from the scope of this disclosure.

In addition, the present disclosure is described in connection with one or more embodiments. The descriptions set forth below, however, are not intended to be limited only to the embodiments described. To the contrary, it will be appreciated that there are numerous equivalents and variations that may be selectively employed that are consistent with and encompassed by the disclosures below.

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

Aspects of the present disclosure relate to various aircraft vehicle systems, methods and devices having turboelectric propulsion architecture with an aft boundary layer ingesting propulsion system. Related aspects relate to novel turboelectric propulsion architecture with an aft boundary layer ingesting propulsion system that may be configured for one or more vehicle systems.

Such an aircraft vehicle may include a single-aisle turboelectric aircraft with an aft boundary layer propulsor (STARC-ABL) and may take advantage of turboelectric propulsion architecture and the ability to distribute the power. In one example embodiment, a vehicle may be single-aisle transport aircraft, e.g., able to carry about 150 passengers or more over a range of approximately 3,500 nautical miles, similar to a Boeing B737 or an Airbus A320. While systems and apparatuses in accordance with the present disclosure are described for use in the single-aisle (i.e., narrow-body) class of commercial transport aircraft, such systems and apparatuses may also be employed in any number of various other types of vehicles, including but not limited to aircraft of various other sizes and configurations, such as twin-aisle aircraft (i.e., wide-body aircraft), jumbo jets, regional jets and the like.

Certain turboelectric propulsion architecture vehicles are described in Welstead et al., AIAA Technical Paper 2016-1027, “Conceptual Design of a Single-Aisle Turboelectric Commercial Transport with Fuselage Boundary Layer Ingestion,” the contents of which are incorporated by reference herein in its entirety.

The turboelectric propulsion architecture may include hydrocarbon fuel-burning turbomachinery coupled to one or more generators. The one or more generators may be configured to distribute power to an aft propulsor positioned in an aft portion of the vehicle, e.g., aft of the turbomachinery. For example, the aircraft vehicle may be a tube-and-wing configuration, and the turbomachinery may include two underwing mounted turbofans. Attached to each turbofan is a generator that extracts mechanical power from the fan shaft and converts it to electrical power. Electrical wires send power to a rear mounted boundary layer ingesting, electrically powered fan.

Such turboelectric propulsion architecture may, in accordance with one or more embodiments, provide synergistic propulsion airframe integration by decoupling power producing components from thrust producing components. Specifically, decoupling power producing components from thrust producing components allows for both sets of components to be physically separated, with each operating at peak efficiency, or near peak efficiency conditions rather than a compromise between the two. Such operation in turn increases overall thermal efficiency of the vehicle. For example, in a typical narrow-body aircraft, an example turboelectric system may have an economic fuel burn reduction on the order of 7% and a design mission fuel burn reduction on the order of 12% compared to convention turbomachinery-only configurations. Efficiencies can be improved by a number of other design considerations in the turboelectric system architecture. For example, the aft propulsor may include a distributed fan, which increases the effective bypass ratio while reducing fan pressure ratio and boundary layer ingestion, which in turn increases overall vehicle efficiency through propulsive efficiency increases and reduced vehicle wake dissipation.

As shown in FIGS. 1A and 1B, a vehicle 100 is illustrated in a side view and a perspective view, respectively. Similar to many types of modern aircraft, vehicle 100 includes a wing-body configuration with underwing propulsors. In particular, vehicle 100 includes a tube-like fuselage 110 and a pair of wings 120 (e.g., fixed wings) on opposing sides of and coupled to fuselage 110. A pair of wing propulsors 200, e.g., turbofans, is coupled to the pair of wings 120, e.g., each below a respective wing 120. Wing propulsors 200 may be coupled to lower surfaces of wings 120 (also referred to an underwing propulsors). An aft or rear propulsor 300 is coupled to a rear portion of fuselage 110. Rear propulsor 300 may be electrically coupled to wing propulsors 200 and may be configured to receive at least a portion of power extracted from the wing propulsors 200. Vehicle 100 may also include T-tail empennage 150, sized and positioned based on placement of the rear propulsor 300. As shown in FIGS. 1A and 1B, T-tail empennage 150 may be positioned at an aft end of fuselage 110 and may be positioned above rear propulsor 300.

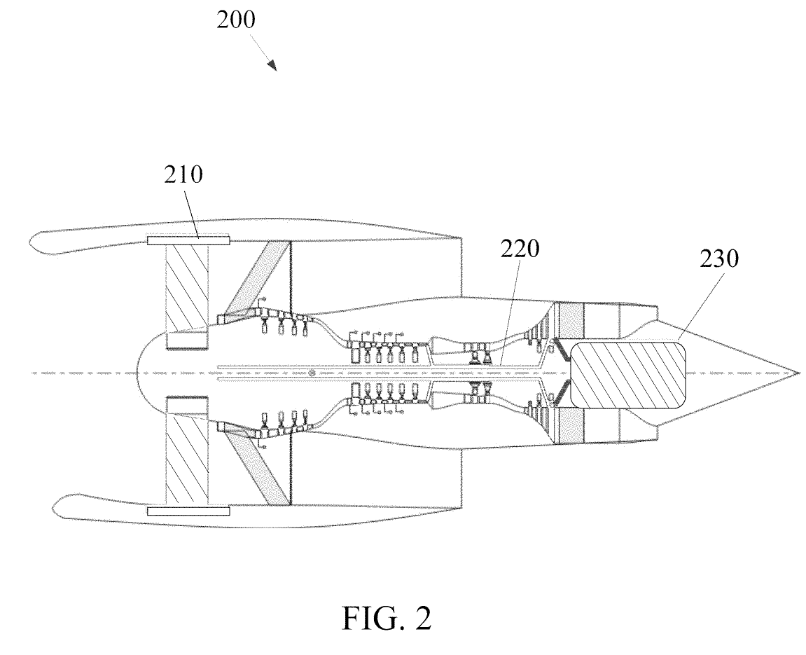

Wing propulsor 200, for example as shown in the cross-sectional view of FIG. 2, may include a turbofan 200. Turbofan may include conventional turbofan components including, but not limited to, an annular fan 210, and a fan shaft 220 driven by rotation of fan 210. Generator 230 configured to extract power from fan shaft 220 for sending to the rear propulsor. In such examples, wing propulsors 200 may burn traditional jet fuel and may provide thrust to the vehicle throughout a mission. Fan 210 may operate at a given fan pressure ratio, e.g., approximately 1.45.

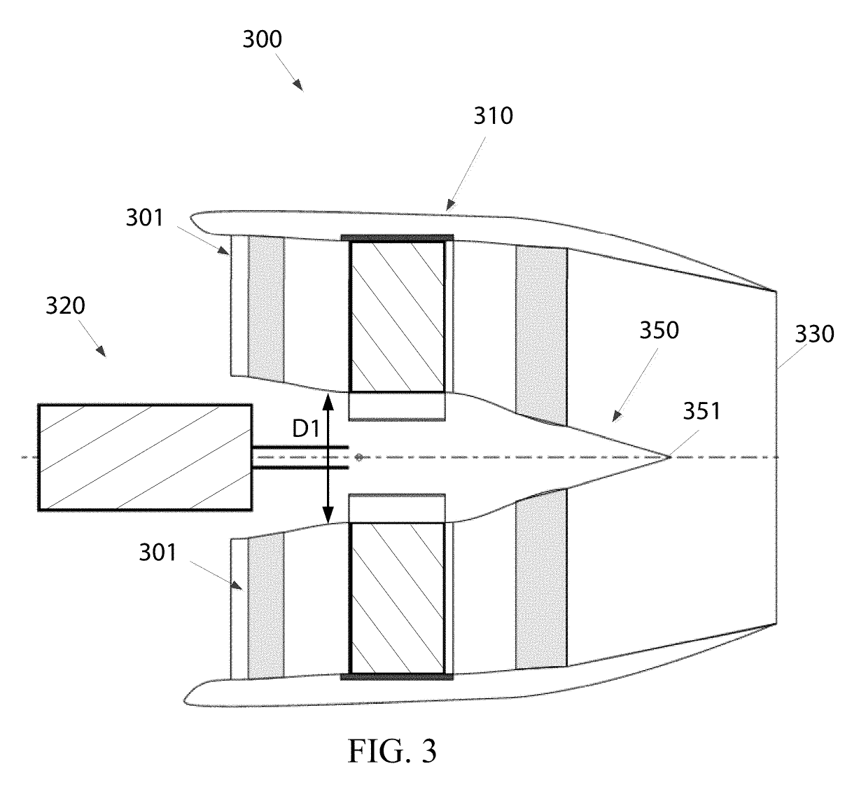

Rear propulsor 300 may be sized and positioned to ingest a portion of a boundary layer at the rear portion of fuselage 110. In some examples, the boundary layer may be an axisymmetric or substantially axisymmetric boundary layer. As shown in the cross-sectional view of rear propulsor 300 in FIG. 3, an electric motor 320 may be included and may be configured to drive the rear propulsor 300, e.g., by running at a substantially constant power level. Electric motor 320 may be powered by the extracted power from the wing propulsor 200. Aft propulsor 300 may be located on the tail cone 350 of a vehicle (e.g., an aft tail cone of fuselage 110 of FIGS. 1A and 1B) such that a nozzle exit plane 330 extends slightly past tip 351 of the tail cone 350.

Rear propulsor 300 may include a ducted electrically driven fan 310. Fan 310 may operate at a fan pressure ratio of about 1.25. In some examples, fan 310 of rear propulsor 300 may be designed to operate at a constant 3500 horsepower at high throttle settings, and at a reduced horsepower at low throttle settings. A throttling schedule for fan 310, however, may be further modified or optimized for a greater variety of conditions, based on mission requirements. A more complex throttling scheme may provide increased system benefits.

In accordance with certain example embodiments, a diameter D1 of an inner portion of aft propulsor 300 may be sized based on a diameter of tail cone 350 so as to couple aft propulsor 300 over tail cone 350 of a vehicle. An axial location of inlet 301 may be determined by a computed length of the entire aft propulsor 300. Axial location of inlet 301 may be important because flow conditions of the local boundary layer may vary with the axial location, especially as flow nears tip 351 of tail cone 350. As such, thermodynamic performance and flow path computation may be tightly coupled.

In some examples, wing propulsors 200 may be powered by fuel combustion and aft propulsor 300 may be electrically powered via wing propulsors 200. An electric system (not shown) may electrically couple wing propulsors 200 to rear propulsor 300. Electric system may include standard electrical components well-known to a person of ordinary skill in the art. For example, a cabling system may be configured to electrically connect the generator 230 to the electric motor 320. The electric system may further include an inverter coupled to generator 230. In some examples, wing propulsors 200 and rear propulsor 300 may each be axisymmetrically-shaped. A diameter, such as an outer diameter, of the wing propulsors 200 may be smaller than a correlated diameter, such as an outer diameter, of the rear propulsor 300.

Inclusion of rear propulsor 300 in addition to wing propulsors 200 allows for extremely efficient operation and allows for wing propulsors 200 to be decreased in size, as opposed to a vehicle lacking rear propulsor 300 and associated turboelectric system components. Accordingly, inclusion of a rear propulsor, such as rear propulsor 300, and associated turboelectric system components may allow for reduced-size wing propulsors, thus offsetting weight penalties associated with the rear propulsor and associated turboelectric system component. Accordingly, wing propulsors 200 may be sized to meet system thrust requirements and/or wings 120 may be sized to meet mission and performance requirements, based on consideration of system improvements due to include of rear propulsor 300 and other turboelectric system components. In particular, wing area and thrust may be varied subject to various performance requirements, while minimizing fuel burn.

Vehicles as described herein may utilize one or more example turboelectric system architectures in a minimalist way, such that only a partial distribution of power is utilized with wing propulsors 200 still providing a significant amount of thrust. For example, wing propulsors 200 may provide about 80% power during takeoff and about 55% power at a top of climb (TOC) condition. In other examples, wing propulsors 200 may provide more or less thrust than the above-described amounts during takeoff and/or TOC conditions, without departing from the scope of the present disclosure. The turboelectric system architecture may enable decoupling of the power-producing elements (e.g., generators) from the thrust-producing elements (e.g., wing propulsors 200 and rear propulsor), thus allowing for distribution of the turboelectric system.

Accordingly, the turboelectric system architecture may be implemented without the added system complexity of a fully distributed propulsion system, e.g., including numerous additional electrical system components, motors, and fans. Instead, systems and apparatuses of the present disclosure may implement the turboelectric architecture in a simplified manner. The turboelectric system architecture may employ an electrical system known to those of skill in the art, e.g., avoiding potential dependence on a complex cryogenic cooling system.

According to one particular example for sizing and designing a turboelectric system architecture for a typical, single-aisle aircraft vehicle, the following design pressure ratios, temperatures, efficiencies, specific powers, specific weights and approximate efficiencies were estimated for the turbofan component (i.e., the wing propulsor) and other electrical and thermal management system (TMS) components and are listed in Table 1.

TABLE 1
Design assumptions for a propulsion system architecture, according to
one example.

| Turbofan | Pressure Ratio or | | Electrical/TMS | Specific Power or | |
|---|---|---|---|---|---|
| Component | Total Temperature | Efficiency | Component | Specific Weight | Efficiency |
| Fan | 1.45 | 93.9% | Generator | 8 hp/lb | 96.0% |
| LPC | 1.45 | 92.0% | Motor | 8 hp/lb | 96.0% |
| HPC | 27.9 | 90.6% | Inverter | 10 hp/lb | 98.0% |
| HPT | 2800*R | 92.5% | Cable | 3.0 kg/m | 99.5% |
| LPT | 1690*R | 94.1% | Circuit Protection | 33 kg/MW | — |
| Tall Cone Fan | 1.25 | 95.7% | TMS | 0.68 kW/kg | — |

Rear propulsor 300 may be sized and positioned to ingest a portion of a boundary layer at a rear portion of vehicle driven by the turboelectric propulsion system. Such a boundary layer may be axisymmetric where the vehicle body is substantially axisymmetric, e.g., the tube-like fuselage 110 of FIGS. 1A and 1B.

An accurate representation of boundary layer velocity and total pressure profiles at the inlet 301 of aft propulsor 300 has been considered in accordance with example embodiments. A flow regime in a region of tail cone 350 may be especially complex due to effects of diffusion of the airstream into the tail cone region being superimposed on a viscous boundary layer coming from a cylindrical section of the fuselage. This interaction may make determining an equivalent flat plate distance (for use in flat-plate boundary layer estimation methods) difficult.

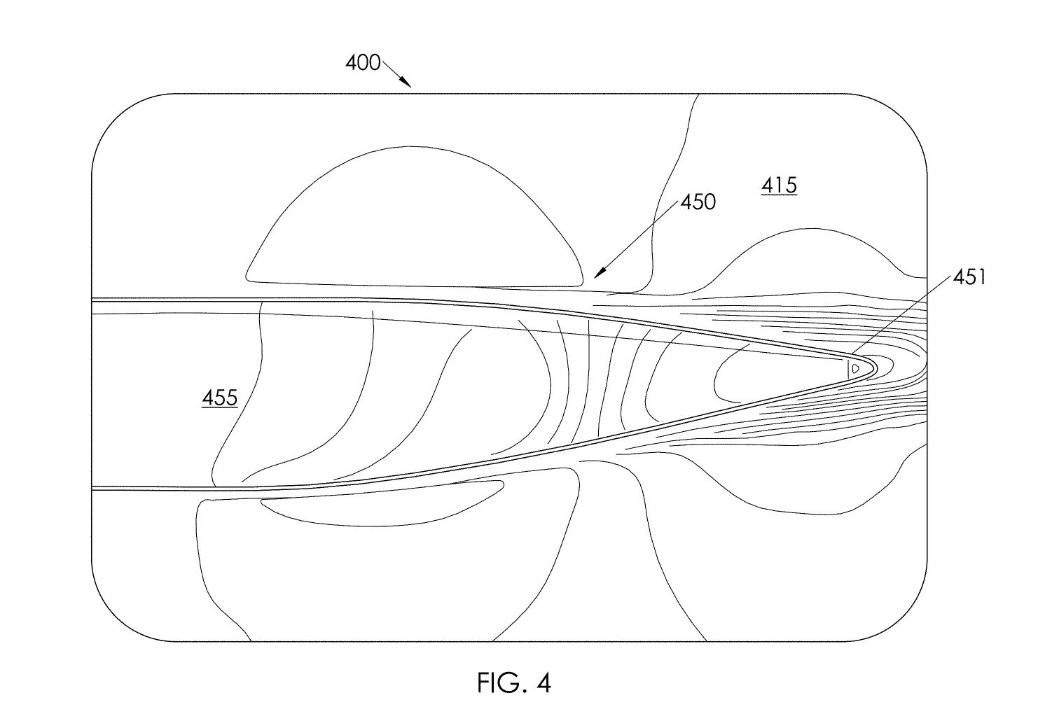

FIG. 4 schematically shows an aft boundary layer profile 400 along a tail cone 450 of a vehicle in accordance with one or more aspects of the present disclosure. The aft boundary layer profile may be based on results of a computational fluid dynamics (CFD) model superimposed on tail cone 450. Boundary layer profile 400 may include color contours 455 on a surface of the tail cone representing a pressure coefficient (Cp) of flow at a surface of tail cone 450. Boundary layer profile 400 may also include color contours 415 in spaces around the surface of tail cone 450 representing a local Mach number. In other words, lines of contours 415 represent constant Mach number. Rapid spreading of the lines towards tip 451 of tail cone 450 may be an indication of a degree to which an adverse pressure gradient of diffusing flow in a region of tip 451 rapidly thickens boundary layers.

In some examples, there may be an approximately 50-inch height of a velocity deficit layer in the region near tip 451 of tail cone 450. This height may be much greater than a boundary layer height of a flat plate of similar length. Additionally, a relatively low loss of total pressure in this reduced velocity layer may occur. The combination of these two details indicate that much of a momentum deficit in the boundary layer may be due to diffusion (which tends to preserve total pressure) rather than due to viscous boundary layer losses (which tends to dissipate total pressure). The effect of a reduction in average inlet velocity may be mainly noted in a reduction in inlet drag. The effect of a reduction in total pressure may be mainly noted in a reduction in nozzle gross thrust. Thus, a flow field such as observed in the example embodiment of FIG. 4 may have the advantage of reducing inlet drag while not suffering as much loss in gross thrust as would be seen if the velocity deficit were entirely due to viscous losses.

An integrated value of a mass-averaged Mach number and total pressure may be calculated for each height in the boundary layer. The mass-averaged values may then be normalized by the freestream Mach number and total pressure for use at various different flight conditions. The dimensioned height value in the boundary layer may also be normalized by the full height value of the boundary layer. The height of the boundary layer may be assumed to vary with only Mach number, so that an estimate of the height at any Mach number may be obtained by interpolating between the two known heights at the two given Mach numbers. By normalizing both the x and y values of the boundary layer map, interpolation between the fully normalized boundary layer shapes may be possible to get a normalized profile shape at a desired Mach number. Un-normalized boundary layer profiles at flight conditions for which the data is unknown may be obtained using boundary layer height for the given flight Mach number (interpolated from a table of boundary layer height versus Mach number) and a flight Mach number and total pressure.

Similar methodology may be used to expand a boundary layer map to have normalized boundary layer curves as both a function of Mach number and altitude when data for more flight conditions is known. A boundary layer map may also be expanded to include boundary layer shapes as a function of aft fan power to reflect a suction effect of the aft fan on a shape of an upstream flow field at different power levels. By compactly representing a large amount of pre-calculated data, a more complex propulsion/airframe interaction may be included in a zeroth order cycle model.

In certain examples, normalized boundary layer profiles may be used to compute an average inlet Mach number and total pressure for a given capture height of the aft fan. Such computation may be used to approximate boundary layers for different axial locations on the tail cone. A velocity deficit in a region of the tail cone near the tip may be driven more by diffusion rather than viscous drag. This effect may be shown by a greater spread in the mass averaged Mach number lines than in the total pressure lines (since diffusion preserves total pressure while viscous losses, by definition, do not).

A difference between an average velocity for a given capture height and a freestream velocity may represent momentum deficit for the flow up to that height. As more of the boundary layer is captured, more of the total momentum deficit may be captured. Based on the velocity curve in the boundary layer following a ( 1/7)^{th} order power curve, the momentum capture versus boundary layer capture curve may be nonlinear. Accordingly, a momentum deficit in a bottom 10% of the boundary layer may be much larger than in a top 10% of the boundary layer. An example baseline system, e.g., with less than 50% of the boundary layer captured may correspond to over 70% of the momentum deficit captured. In some examples, capturing 20% of the boundary layer may capture 40% of the total momentum deficit, and capturing an additional 20% of the boundary layer may only captures an additional 25% of the momentum deficit.

For a given fan pressure ratio of a fan of the wing propulsor, the shaft power to the fan, and hence motor power, may increase with increasing boundary layer capture. For example, a power of 3500 horsepower may be a maximum power that can be extracted from the wing propulsors. This amount of power may be sufficient to capture approximately 45% of the total boundary layer height, and may also be sufficient to capture approximately 70% of the total momentum deficit. Capturing the entire boundary layer may require more power, which may not be a beneficial tradeoff for extra weight and losses in the electrical system associated with capturing the entire boundary layer, assuming that the wing propulsors are capable of directing more power away from the fans and to the generators. In fact, in some examples, an optimum fraction of captured boundary may be less than 100%.

Design parameters of a system employing turboelectric system architecture in accordance with one or more aspects of the present disclosure, may be compared to a conventional configuration, e.g., powered by turbofans only. A summary of a resulting design according to an example is shown in Table 2 and compared to a baseline turbofan example employing two turbofans (i.e., Baseline Turbofans). In particular, Table 2 shows design parameters of a system employing turboelectric system architecture specific to the wing propulsors (i.e., Generator Turbofans), the aft propulsor (i.e., BLI Tail Cone Propulsor), and the total turboelectric system (i.e., STARC-ABL System).

TABLE 2
Propulsion system performance for a baseline conventional turbofan and a
system employing turboelectric system architecture in accordance with one or more aspects of
the present disclosure, where propulsion system thrust requirements for sizing include TOC
thrust of approximately 6,800 pounds and RTO thrust of approximately 28,340 pounds.

| | | Baseline | | Generator | | BLI Tail Cone | | STARC-ABL | |
|---|---|---|---|---|---|---|---|---|---|
| | | Turbofans | | Turbofans | | Propulsor | | System | |
| | units | TOC | RTO | TOC | RTO | TOC | RTO | TOC | RTO |
| Thrust | lb | 6,800 | 34,920 | 4,060 | 22,780 | 3,210 | 5,560 | 7,260 | 28,350 |
| TSFC | lb/hr/lb | 0.4410 | 0.2922 | — | — | — | — | 0.3875 | 0.3032 |
| Thrust/HP | lb/hp | 0.64 | 0.99 | 0.60 | 0.86 | 0.92 | 1.60 | 0.72 | 0.96 |
| OPR | — | 58.0 | 51.0 | 58.0 | 49.6 | 1.25 | 1.08 | — | — |
| BPR | — | 11.3 | 11.9 | 6.4 | 6.9 | — | — | 14.4 | 13.3 |
| FPR | — | 1.45 | 1.39 | 1.45 | 1.49 | 1.25 | 1.08 | — | — |
| % Nc | — | 100% | 93.2% | 100% | 100% | 100% | 62.1% | — | — |
| LPT Power | hp | 5,960 | 19,490 | 4,940 | 14,840 | — | — | — | — |
| Fan Power | hp | 5,320 | 17,705 | 3,005 | 12,900 | 3,500 | 3,500 | — | — |
| Generator/Motor | hp | — | — | 3,870 | 3,870 | 3,500 | 3,500 | — | — |

The example as shown in Table 2 was sized to meet or exceed the thrust required by an aircraft at the top of climb (TOC) and rolling takeoff (RTO) flight conditions. The TOC flight condition shown in Table 2 is based on a climb of approximately 37,574-feet at a Mach number of 0.7 and standard day conditions with total vehicle thrust of approximately 6,797 pounds. The RTO condition shown in Table 2 is based on sea level at a Mach number of approximately 0.2153 and hot day conditions (+27° Rankine) with a total vehicle thrust of approximately 28,342 pounds. The motor driving the aft propulsor may be assumed to have a continuous rated power of 3,500 horsepower in a baseline configuration.

The combination of all individual component efficiencies in the electrical system may give a fan turbine shaft to aft propulsor fan shaft efficiency of approximately 90.4%. As a result, the generator size may be set at 1,935 horsepower each (for two generators) or 3,870 horsepower total. The total propulsion system may be sized at the TOC condition such that the fan of the aft propulsor runs at approximately 100% corrected speed at an input power of 3,500 horsepower. The wing propulsors may then be sized to provide the remaining thrust required while also driving the generators. The result is that thrust from an individual wing propulsor is approximately only 2,030 pounds at TOC, as compared to the 3400 pounds required of each baseline turbofan on an example conventional configuration. Thus, the diameter of the fans as well as nacelles of the wing propulsors may be smaller than the respective diameters of the baseline turbofans. However, a core airflow rate may not be substantially different due to the fan turbine generating similar total shaft power.

Off-design conditions may also be executed to ensure that the required RTO thrust is still met or exceeded. If the thrust produced at the RTO was less than the required value, the design thrust at the TOC point was increased until the RTO thrust was sufficient. For the 3500-horsepower baseline motor size, the thrust lapse rate of the total system is such that the RTO thrust is the more constraining and so the TOC design thrust shown in Table 2 was increased to approximately 7,260 pounds (463 pounds more than the required thrust).

A power management scheme may be used to determine a maximum system thrust to match the wing propulsors to a design fan percent corrected speed with constraints on maximum turbine inlet temperature (T4) while the aft propulsor was run at a constant 3,500 horsepower, regardless of altitude or speed. Running the aft propulsor at 3,500 horsepower resulted in 100% corrected fan speed for the aft propulsor at the TOC sizing point, but only 62% at the RTO point. This may be due to power required to run the fan at a given corrected speed increasing considerably as the altitude decreased and air density increased. To run the aft propulsor at the same corrected speed at the RTO point as the TOC point may entail a considerably larger and thus heavier electrical power system. However, as a result of operating the aft propulsor at a constant shaft power, the percentage of the thrust from the wing propulsors increased from about 56% of the total at the TOC point to 80% at the RTO point. This may be likely why the RTO thrust as exemplified in the results of Table 2 was the more constraining of the two required thrust values.

At part power the propulsion system may be matched to a fraction of the wing propulsor fan max power corrected speed and a percentage the aft-fan motor rated power. Due to effects of boundary layer ingestion, the amount of thrust per shaft horsepower may be higher in the aft propulsor than in the wing propulsors (e.g., about 0.92 pounds/horsepower versus approximately 0.67 pounds/horsepower). In order to keep as much of the part power thrust coming from the more efficient thrust source for as long as possible, motor power may be maintained at a maximum while reducing the thrust of the overall system. The limiting factor may be that as fuel flow is reduced in the wing propulsors while the generator power remains constant, the low pressure compressor (LPC) of the wing propulsors may be driven towards stall. Once a minimum LPC stall margin is reached, the power to the aft propulsor may be reduced in order to stay at that minimum stall margin.

A summary of example non-electrical portion sizes and weights of a baseline conventional turbofan (i.e. Baseline Turbofan) as well as a system employing turboelectric system architecture in accordance with one or more aspects of the present disclosure, specific to wing propulsors (i.e., Generator/Turbofan) and the aft propulsor (i.e. BLI Propulsor) is shown in Table 3

TABLE 3
Non-electric propulsion system component sizes and weights for a
baseline conventional turbofan, and a wing propulsor and an aft
propulsor in an example system employing turboelectric system
architecture in accordance with one or more aspects of the
present disclosure.

| | Baseline | | |
|---|---|---|---|
| Component | Turbofan | Generator/Turbofan | BLI Propulsor |
| Fan Diameter | 70 in | 52 in | 81 in |
| Nacelle Max Diameter | 78 in | 58 in | 90 in |
| Nacelle Length | 156 in | 115 in | 111 in |
| Bare Engine Weight | 4,460 lb | 2,510 lb | 1,370 lb |
| Nacelle Weight | 3,910 lb | 1,630 lb | 700 lb |
| Total Pod Weight | 8,370 lb | 4,140 lb | 2,070 lb |

Examples of design assumptions for specific power, efficiency, and size for the electrical system of a system employing turboelectric system architecture in accordance with one or more aspects of the present disclosure, as well as the resulting weights of the major components and the total weight of the electrical system, is shown in Table 4.

TABLE 4
Electric system sizing and weight estimates for an example
turboelectric system architecture in accordance with one or
more aspects of the present disclosure.

| Component | Assumption | Efficiency | Size | Weight |
|---|---|---|---|---|
| Electric Motor | 8 hp/lb | 96.0% | 3,500 hp | 440 lb |
| Inverter | 10 hp/lb | 98.0% | 3,500 hp | 350 lb |
| Generator (2) | 8 hp/lb | 96.0% | 2 @ | 480 lb |
| | | | 1,937 hp | |
| Cable (2 × 93′) | 3.85 kg/m | 99.6% | 1.44 MW | 480 lb |
| Circuit | 750 V/1926 amps | — | — | 240 lb |
| Protection | 0.5 * Cable Weight | | | |
| TMS | 0.68 kW/kg | — | 279 kW | 910 lb |
| Total System | — | — | — | 2,930 lb |

Examples of total propulsion system weight are shown in Table 5. As shown in the example represented in Table 5, the total system weight of the turboelectric system (including two wing propulsors, one aft propulsor, electrical system and TMS) may be less than a weight of a baseline conventional turbofan system (including two baseline turbofans). While the electrical propulsion system may add approximately 2,930 pounds to the system and the non-electrical portions of the aft propulsor may add another approximately 2,070 pounds for a total of approximately 5,000 pounds not present in a conventional turbofan system, the combined weight of the two wing propulsors without the generators is approximately 8,460 pounds less than the two base turbofans. This may be due mostly to the fact that the fan size of the wing propulsors may be reduced from approximately 70 to 52 inches in diameter. Also the nacelle and thrust reverser for the wing propulsors may be smaller and lighter. As a result, the total system weight of a system employing turboelectric system architecture in accordance with one or more aspects of the present disclosure may be approximately 3,460 pounds lighter a conventional baseline turbofan system.

TABLE 5
Total propulsion system weights for a baseline conventional turbofan
and an example system employing turboelectric system architecture
in accordance with one or more aspects of the present disclosure.

| | Baseline | STARC-ABL |
|---|---|---|
| Subsystem | Turbofan | Propulsion System |
| Non-electrical | 16,750 lb | 10,370 lb |
| Electrical | — | 1,990 |
| TMS | — | 910 lb |
| Total | 16,750 lb | 13,270 lb |

Even in examples where the total system weight may not be lighter than a conventional turbofan, the above results indicate that the aft propulsor, although physically contributing weight to the system, provides performance benefits that allow other components to be reduced in size and weight. In particular, there are parts of the propulsion system which may become lighter as a result of adding an aft propulsor to the propulsion system. The final system weight may depend on a balance between the changes that add weight to the system with those that remove weight from the system. Regardless of exact weights, however, the final system weight may be less than what it would be if the electrical system and the aft propulsor were simply added to the baseline turbofan weight.

The above analysis is based on both propulsion systems being designed to the same thrust requirements. When a vehicle is re-optimized around the lower fuel weight that results from the better fuel efficiency of the turboelectric propulsion system, the takeoff gross weight (TOGW) may likely be less than the baseline system leading to a lower required thrust. A lower required thrust in turn may indicate that the entire propulsion system size and thus weight may be reduced. Thus, even if the thrust to weight of the aft propulsor is less than the baseline turbofan, the propulsion system weight of an optimized system employing turboelectric system architecture in accordance with one or more aspects of the present disclosure may still be less than that of the baseline system.

According to one or more aspects of the present disclosure, there may be significant TSFC improvements and fuel burn reductions on both the economic mission and design mission ranges than conventional turbofan systems. For example, turboelectric propulsion architecture may result in nearly a 15% improvement in TSFC at the start of cruise condition. This translates into approximately 7% and 12% block fuel burn savings for the economic and design missions, respectively. These improvements may be observed despite an operational equipment weight (OEW) and takeoff gross weight (TOGW) increase from the baseline conventional turbofan configuration due to larger wing and empennage surfaces. The sea level static (SLS) thrust of wing propulsors may be able to be reduced due to the addition of the aft propulsor. Further, the aft propulsor may be an extremely efficient thrust producing device due to the ingested boundary layer and the lack of power lapse with altitude.

Another benefit of certain example systems employing turboelectric system architecture may be the reduced wing propulsor size and weight. This resulted from the lack of power lapse as a function of altitude in the electric motor and the increase in propulsive efficiency of the aft propulsor allowing the wing propulsors to be downsized. As the fan diameter of the wing propulsors is decreased, the wing propulsor system weights, including nacelle, may decrease dramatically. This reduction in wing propulsor weight may offset the additional component weights for the turboelectric system, resulting in a net propulsion system weight reduction. The decrease in wing propulsor size may also provide a wetted area reduction for the nacelle, resulting in additional viscous drag benefits.

An additional benefit of systems employing turboelectric system architecture may be a reduction in total wake dissipation. Although only a secondary effect when compared to the propulsive efficiency increase due to the aft propulsor, inclusion of this effect may further improve the overall system fuel burn benefit. The fuselage, e.g., leading toward the rear nacelle and a nacelle outer mold line, may be shaped to provide a static pressure field resulting in a forward axial force or thrust. Further, an electrical rather than mechanical connection of the wing propulsors and the aft propulsor, combined with the ability of electrical system components to independently vary the torque and speed, may allow the motor and generator to shift the operating line of the wing propulsors' fan, LPC and LPT, and the aft propulsor's fan. A ratio of the fan shaft speed of the wing propulsors to the fan shaft speed of the aft propulsor may be varied during operation, allowing each system to operate at its own optimal operating point. This operational benefit may also increase turbomachinery efficiency and operability at off-design conditions.

Systems employing turboelectric system architecture may also be associated with wing geometries which are different than conventional turbofan systems, e.g., having a larger wing area. Further, the shape of the design space is significantly changed for systems employing turboelectric system architecture. Specifically, the shape of the economic block fuel burn contours may change from being equally sensitive to thrust and wing area (in conventional turbofan systems) to being mostly sensitive to SLS thrust. Another other major design space change may be the relief of the initial cruise altitude capability (ICAC) constraint, which allowed the SLS thrust to be decreased providing a significant fuel burn benefit.

Further design parameter may be adjusted to optimize systems in accordance with the present disclosure. For example, electrical system efficiency and aft propulsor FPR may have the greatest impact on TSFC, but the motor horsepower sensitivity may also be significant. Increasing the motor size beyond the 3500 horsepower may improve the TSFC, but at the expense of motor volumetric size and weight to the point of potentially being prohibitive. Despite the large sensitivities to the motor design horsepower, electrical efficiency, and FPR, example data points show that the turboelectric system in accordance with the present disclosure may result in a TSFC better than a conventional propulsion system. Increasing the aft propulsor FPR may decrease the total propulsion system weight as the size of the aft propulsor fan is decreased. Further, increasing the electrical efficiency may decrease the propulsion system weight. Notably, the total electrical system efficiency would have to be reduced significantly before the TSFC and propulsion system weight would equal that of a conventional turbofan system. This implies that having a cryogenic cooling system to enable superconducting electrical components may not be needed for systems employing turboelectric system architecture in accordance with the present disclosure.

Systems employing turboelectric system architecture in accordance with one or more aspects of the present disclosure may provide a significant fuel burn benefits. Some examples indicate a 7% block fuel burn reduction for the economic mission, and 12% block fuel burn reduction for the design mission. Key sources of this benefit may be an increase in propulsion system efficiency from the aft propulsor that ingests only a portion of the boundary layer, and the downsizing of the wing propulsors, which helps offset the weight of the additional turboelectric system components.

Economic block fuel contours associated with systems employing turboelectric system architecture in accordance with one or more aspects of the present disclosure may be primarily sensitive to thrust only, as opposed to conventional baseline turbofan systems which are generally equally sensitive to thrust and wing area. The initial cruise altitude capability (ICAC) constraint may also be alleviated in such systems, thus allowing the economic block fuel contours and takeoff field length requirements to drive optimal designs.

Sensitivity analyses may be run to better understand the relationship of system benefits to some of the turboelectric system design assumptions, and to indicate the technology levels required to make the STARC-ABL concept viable, providing a technology development road map. For example, thrust-specific fuel consumption (TSFC) may be sensitive to a motor horsepower, aft-fan fan pressure ratio (FPR), and/or total electrical system efficiency. However, examples employing turboelectric propulsion system architecture, as described herein, still had a TSFC better than the conventional configurations. Total propulsion system weight may also be sensitive to FPR and electrical system efficiency, but may be fairly insensitive to motor horsepower over a broad range of horsepower (e.g., between approximately 2275 and 3500 horsepower). Propulsion system weights may contain some uncertainty due to modeling methods used and may require additional scrutiny. Nonetheless, the trend in weight reduction of the wing propulsors offsets some or all turboelectric components remains.

Overall, systems and methods employing turboelectric propulsion system architecture in accordance with one or more aspects of the present disclosure may provide significant fuel burn benefits when compared to conventional configurations.

All references contained herein are hereby incorporated by reference in their entirety.

In keeping with the foregoing discussion, the term “propulsor” is intended to encompass the various components configured to provide propulsion to the vehicle, vis-à-vis the methods and examples of the present disclosure. For example, propulsors as discussed herein may include propellers, rotors, fans, ducted fans, or other thrust generating devices.

While preferred embodiments and example configurations of the invention have been herein illustrated, shown and described, it is to be appreciated that various changes, rearrangements and modifications may be made therein, without departing from the scope of the invention as defined by the claims. It is intended that specific embodiments and configurations disclosed are illustrative of the preferred and best modes for practicing the invention, and should not be interpreted as limitations on the scope of the invention as defined by the appended claims and it is to be appreciated that various changes, rearrangements and modifications may be made therein, without departing from the scope of the invention.

While the invention has been described with respect to specific examples including presently preferred modes of carrying out the invention, those skilled in the art will appreciate that there are numerous variations, combinations, and permutations of the above described systems and methods. Those skilled in the art will understand that various specific features may be omitted and/or modified in without departing from the invention. Thus, the reader should understand that the spirit and scope of the invention should be construed broadly as set forth in the appended claims.

What is claimed is:

1. A turboelectric vehicle comprising:
a fuselage;
a wing coupled to the fuselage;
a wing propulsor coupled to the wing; and
a rear propulsor positioned at a rear portion of the fuselage and configured to be electrically coupled to the wing propulsor,
wherein the rear propulsor is further configured to receive power extracted from the wing propulsor.

2. The turboelectric vehicle of claim 1, wherein the wing propulsor comprises:
a turbofan including a fan;
a fan shaft configured to be driven by a rotation of the fan; and
a generator configured to extract power from the fan shaft, wherein the generator is in operative communication with the rear propulsor.

3. The turboelectric vehicle of claim 1, wherein the rear propulsor is sized and positioned to ingest a portion of a boundary layer at the rear portion of the fuselage.

4. The turboelectric vehicle of claim 1, wherein the rear propulsor is positioned to cover a rear tail cone of the fuselage.

5. The turboelectric vehicle of claim 1, further comprising an electric motor configured to drive the rear propulsor and powered by the extracted power from the wing propulsor.

6. The turboelectric vehicle of claim 1, wherein the turboelectric vehicle is a transport aircraft.

7. The turboelectric vehicle of claim 1, wherein the wing comprises a pair of wings positioned on opposing sides of the fuselage, and wherein the wing propulsor comprises a pair of turbofans, each positioned on a lower surface of the pair of wings.

8. The turboelectric vehicle of claim 1, further comprising a T-tail empennage positioned at an aft end of fuselage and above the rear propulsor.

9. A turboelectric propulsion system comprising:
a wing propulsor configured to be powered by fuel combustion;
an electrically-powered rear propulsor located aft of the wing propulsor; and
an electric system electrically coupling the wing propulsor to the rear propulsor and including:
a generator configured to be coupled to the wing propulsor and to extract power generated by the wing propulsor;
an electric motor configured to receive the extracted power from the generator and to provide a power source to the rear propulsor; and
a cabling system configured to electrically connect the generator to the electric motor.

10. The turboelectric propulsion system of claim 9, wherein the electric system further comprises an inverter coupled to the generator.

11. The turboelectric propulsion system of claim 9, wherein the wing propulsor comprises a turbofan including a fan and a fan shaft driven by rotation of the fan and providing power to the generator.

12. The turboelectric propulsion system of claim 9, wherein the rear propulsor comprises a ducted electrically-driven fan.

13. The turboelectric propulsion system of claim 9, wherein the wing propulsor and the rear propulsor are each axisymmetrically-shaped, and wherein an outer diameter of the wing propulsor is smaller than an outer diameter of the rear propulsor.

14. The turboelectric propulsion system of claim 9, wherein the rear propulsor is sized and positioned to ingest a portion of a boundary layer at a rear portion of a vehicle driven by the turboelectric propulsion system.

15. A vehicle comprising:
a main body;
a pair of fixed wings connected to opposing sides of the main body;
a pair of wing propulsors coupled each respective wing of the pair of fixed wings; and
an electrically-driven rear propulsor positioned at a rear portion of the main body and configured to receive power extracted the pair of wing propulsors.

16. The vehicle of claim 15, wherein each of the wing propulsors comprises a turbofan including a fan, a fan shaft driven by rotation of the fan, and a generator configured to extract power from the fan shaft to send to the rear propulsor.

17. The vehicle of claim 15, wherein the rear propulsor is sized and positioned to ingest a portion of a boundary layer along the rear portion of the main body.

18. The vehicle of claim 15, wherein the rear propulsor is positioned over a rear tail cone of the main body.

19. The vehicle of claim 15, wherein the rear propulsor comprises an electric motor powered by the extracted power from the wing propulsor.

20. The vehicle of claim 19, wherein the rear propulsor further comprises a ducted fan configured to be driven by the electric motor.
